(19) United States
(12) Patent Application Publication
(10) Pub. No.: US 2006/0030988 A1
(43) Pub. Date: Feb. 9, 2006

(54) Vehicle occupant classification method and apparatus for use in a vision-based sensing system

(76) Inventor: Michael E. Farmer, Clarkston, MI (US)

Correspondence Address: Martin J. Jaquez, Esq.;JAQUEZ & ASSOCIATES, Suite 100D, 6265 Greenwich Drive, San Diego, CA, 92122, US

(21) Appl. No.: 11/157,465

(22) Filed: Jun. 20, 2005

Related U.S. Application Data
(60) Provisional application No. 60/581,157, filed on Jun. 18, 2004.

(51) Int. Cl. G06F 17/00

(52) U.S. Cl. 701/45; 701/46

(57) ABSTRACT

A method and apparatus for selectively deploying or suppressing automated safety equipment in a vehicle is disclosed. Employing methods obtained from the field of Evidential Reasoning, an occupant classification history process computes the most plausible occupant class, and then selects an appropriate piece of safety equipment to deploy or suppress, based at least in part upon the classification results.

### CROSS-REFERENCE TO RELATED APPLICATIONS AND CLAIM OF PRIORITY

This application claims the benefit of priority under 35 U.S.C. § 119 (e) to U.S. Provisional Application No. 60/581,157, filed Jun. 18, 2004, entitled “Improved Vehicle Occupant Classification Method and Apparatus for Use in a Vision-based Sensing System” (ATTY DOCKET NO. ETN-023-PROV). This application is related to co-pending and commonly assigned U.S. app. Ser. No. (unknown), filed concurrently on Jun. 20, 2005, entitled “Pattern Recognition Method and Apparatus for Feature Selection and Object Classification” (ATTY DOCKET NO. ETN-024-PAP), which claims priority under 35 U.S.C. § 119 (e) to U.S. Provisional Application No. 60/581,158, filed Jun. 18, 2004, entitled “Pattern Recognition Method and Apparatus for Feature Selection and Object Classification.” This application is also related to pending and commonly assigned U.S. pat. Ser. No. 10/944,482, filed Sep. 16, 2004, entitled “Motion-Based Segmentor Detecting Vehicle Occupants using Optical Flow Method to Remove Effects of Illumination” (ATTY DOCKET NO. ETN-029-CIP), which claims the benefit of priority under 35 USC § 120 to the following U.S. applications: “MOTION-BASED IMAGE SEGMENTOR FOR OCCUPANT TRACKING,” application Ser. No. 10/269,237, filed Oct. 11, 2002, pending; “MOTION BASED IMAGE SEGMENTOR FOR OCCUPANT TRACKING USING A HAUSDORF DISTANCE HEURISTIC,” application Ser. No. 10/269,357, filed Oct. 11, 2002, pending; “IMAGE SEGMENTATION SYSTEM AND METHOD,” application Ser. No. 10/023,787, filed Dec. 17, 2001, pending; and “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” application Ser. No. 09/901,805, filed Jul. 10, 2001, pending. All of the U.S. Provisional applications and non-provisional applications described above are hereby incorporated by reference herein, in their entirety, as if set forth in full.

### BACKGROUND

1. Field

The disclosed method and apparatus generally relates to vision-based methods and apparatus, and more specifically to methods and apparatus for processing visual information in order to properly classify a vehicle occupant.

2. Related Art

In a vision-based sensing system, accurate automated classification of an occupant is difficult. Because movement of an occupant within a vehicle (e.g., the occupant may lean over in a seat, lie down, or be taking off apparel) may be sufficient to cause misclassifications to occur, the system may inappropriately deploy automated safety equipment, such as, for example, an airbag, thereby causing injury or death to the occupant. Hence, a vehicle occupant classification method must be sufficiently robust to accurately classify vehicle occupants even when uncertain, imprecise, and occasionally inaccurate information is input to the system. To improve the probability that at any given time the system will correctly classify an occupant, even with inaccurate input information, historical sequences of accumulated information should be integrated with current data. In this manner, the automated safety system will appropriately deploy safety equipment when required, based upon a high confidence classification of the occupant.

The use of computer vision systems in the automobile environment is challenging due to the extreme variations in lighting from bright daylight to dark night. Additionally, in very bright sunlight the image may have considerable dynamic range due to the simultaneous existence of shadows near an occupant's legs and bright patches due to direct sunlight on the head and torso. Because the vehicle is moving, there are both moving and stationary shadows caused by sunlight that further complicate both the static and dynamic performance.

Other complications include the large intra-class variability for three of the classes mentioned above (the empty seat class has very little intra-class variability aside from lighting changes). For the child and rear facing infant seat (RFIS) classes, there are a number of seat types and seating positions that must be recognized and classified, and the similarity between them is often not very high. One further complication is that the RFIS and booster seats may be covered with blankets or other objects. The adult class also has a large amount of intra-class variability due to the following three factors:
1) Variability from the 5^{th} percentile female to the 95^{th} percentile male is 10 inches and 75 pounds.
2) Variability in adult appearance due to hair and clothing variations.
3) Seasonal variability as clothing changes from summer to winter clothing. This variation is present not only from person-to-person, but also for the same person, from season-to-season.
   To summarize, a vision-based system for airbag suppression should be sufficiently robust to accommodate the following conditions:
1) Large intra-class variability of the four classes
2) Camouflaged classes (e.g., blanketed RFIS)
3) Large variation in light levels (day to night)
4) Large lighting variations within an image (shadows to bright direct sunlight)
5) Severe automotive environmental conditions
6) Low cost
7) Extremely high reliability and performance.

Vision-based automated systems have been proposed for passenger vehicles, including a systems described in a paper written by Alberto Broggi and Simona Berte, entitled “Vision-based Road Detection in Automotive Systems: A Real-Time Expectation-Driven Approach”, referred to below as the Broggi paper, published in the Journal of Artificial Intelligence Research, December 1995. The Broggi paper discloses a vision-based road detection system sufficiently fast to cope with real-time constraints imposed by moving vehicle applications, aimed particularly at improving road traffic safety. By reducing mathematical algorithms to a computational architecture, the disclosed vision system processes data and produces results in real-time.

Another vision-based automated system is described in a paper written by John Krumm and Greg Kirk, entitled “Video Occupant Detection for Airbag Deployment”, referred to below as the Krumm paper, and published in the 4^{th} IEEE Workshop on Applications of Computer Vision, October 1998. The Krumm paper discloses a method using video images to determine whether to deploy a passenger side airbag in a vehicle during a crash. Images of the passenger seat (taken by a video camera mounted inside the vehicle) are used to classify the seat as either empty, occupied, or containing a Rear Facing Infant Seat (RFIS). Once classified, the automated system either suppresses or deploys a passenger side airbag. However, the Krumm paper points out that the method does not create an explicit class for occupied seats, such as adult or child, because the appearance of an occupied seat is highly variable and therefore difficult to recognized and classify.

In addition to the aforementioned, various other solutions to the problem of automated deployment of safety equipment have been proposed including, inter alia, solutions using manual switching, object sensors, weight sensors, and multiple sensors. One example of a manual switching solution involves manually disabling a particular safety system, such as an airbag, if a child or infant is potentially at risk of injury. A problem with such a disabling mechanism is that the operator may forget to enable the safety system, once the child or infant is no longer at risk. Under such circumstances, a subsequent adult passenger who might otherwise benefit from the safety system, such as an airbag, will not.

Another example of an automated deployment system involves use of object sensors, whereby a sensing system detects an object in a passenger seat, thereby indicating that an individual is present and activating the airbag only if there is a passenger. However, because this type of sensing system cannot distinguish between classifications of occupants, such as adult, child or infant, such a system is flawed because it may deploy an inappropriate safety device, such as releasing an airbag on a child or infant.

In another automated deployment system, weight sensors are used. Such a solution senses the weight of a passenger and automatically deploys or suspends safety equipment. Typically, a fluid bladder is installed, underneath the passenger seat, to detect the weight of the passenger. This approach is flawed; since such systems will typically offer only two levels of protection, for example a big object or a small object. Hence, a passenger's weight not corresponding to these two levels may be injured. Furthermore, since the sensor is placed underneath the passenger seat, configuration of the passenger seat cushioning, and/or passenger movement can affect the accuracy of the system.

Another proposed solution involves the use of multiple sensors around the passenger seat to sense the presence or absence of an object, and whether the object is sitting, standing or kneeling. Such systems can only determine whether an object is heavy, such as a human being, or lightweight, such as a suitcase, but cannot distinguish the difference between an adult or a child.

One technique used in implementing automated systems is referred to as “Evidential Reasoning”. For example, U.S. Pat. No. 6,125,339 (the '339 patent) discloses a method of providing automatic learning belief functions enabling the combination of different, and possibly contradictory information sources. The '339 patent teaches a system that is capable of determining erroneous information sources, inappropriate information combinations, and optimal information granularities, together with enhanced system performance for a targeting system. Evidential Reasoning processes information that is uncertain, imprecise, and occasionally inaccurate. There are many mathematical methods for performing Evidential Reasoning, the most common of which is the Dempster-Shafer (DS) theory, as described in more detail below.

There is a need for a low-cost, high reliability embedded real-time passenger vehicle safety equipment system. The need exists for a vision-based sensing system, having an improved ability to accurately classify a vehicle occupant, even in the presence of uncertain, imprecise and/or inaccurate input information regarding an occupant. A method, apparatus, and article of manufacture that fulfill these needs are set forth below.

### SUMMARY

An automated vehicle safety system and a vision-based historical vehicle occupant classification method are described. The improved vehicle safety system processes information obtained from a sensory device and updates a classification history in order to accurately categorize a vehicle occupant. The occupant classification thus obtained is used to ensure that automated safety equipment is appropriately deployed within a vehicle. For example, in one embodiment, the automated safety system provides an occupant classification plausibility analysis, based on visual images obtained by the system, in order to deploy or suppress, safety equipment.

In one exemplary embodiment, the disclosed method and apparatus are implemented in a passenger vehicle safety system. The system obtains vision-based information regarding occupants of an automobile which is subsequently used in the classification process. In one embodiment, the information is transferred to a memory storage device and analyzed utilizing a digital signal processor. Employing methods derived from the field of Evidential Reasoning, a classification history processing method is implemented, wherein current occupant classification information is integrated with historical occupant classification information. In one exemplary embodiment, the Dempster-Shafer theory is used to define the classification history processing system. Each potential occupant classification is assigned a range of probabilistic values. The range of values is updated using current information. The range of values provides an estimate of a level of confidence that a particular occupant classification correctly correlates to a present occupant. In a scenario wherein safety equipment deployment is immediately required, the current most plausible occupant classification is used in determining the most appropriate deployment of the vehicle safety equipment.

### BRIEF DESCRIPTION OF THE DRAWINGS

Embodiments of the disclosed method and apparatus will be more readily understood by reference to the following figures, in which like reference numbers and designations indicate like elements.

FIG. 1 shows a partial view of the surrounding environment for one potential embodiment of the disclosed method and apparatus.

FIG. 2 is a high level process diagram illustrating an exemplary embodiment of a history classification processing method.

FIG. 3 is a high level process diagram illustrating a procedure for obtaining and processing information to selectively suppress or deploy vehicle safety equipment.

### DETAILED DESCRIPTION

Overview

Automated safety systems are employed in a growing number of vehicles. An exemplary embodiment set forth below is employed in the context of a passenger vehicle having airbags. The skilled person will understand, however, that the principles set forth herein may apply to other types of vehicles using a variety of safety systems. Such types of vehicles include, inter alia, aircraft, spacecraft, watercraft, and tractors. Moreover, though the exemplary embodiment employs an airbag in the exemplary safety system, the skilled person will recognize that the method and apparatus described herein may apply to widely varying safety systems inherent in the aforementioned respective vehicles. In particular, a method or apparatus as described herein may be employed whenever it is desired to obtain the advantages of automated safety systems requiring accurate classification of vehicle occupants.

The methods and apparatus described below accumulate information about an environment and function to provide a highly accurate decision regarding classification of a vehicle occupant. The methods described below may be implemented by software or firmware executed on a digital signal processor. As used herein, the term “digital processor” is meant generally to include literally any and all types of digital processing devices including, without limitation, digital signal processors (DSPs), reduced instruction set computers (RISC), general-purpose (CISC) processors, microprocessors, and application-specific integrated circuits (ASICs). Such processors may, for example, be contained on a single unitary IC die, or distributed across multiple components. Exemplary DSPs include, for example, the Motorola MSC-8101/8102 “DSP farms”, the Texas Instruments TMS320C6x, Lucent (Agere) DSP16000 series, or Analog Devices 21161 SHARC DSP.

As used herein, the terms “vision-based peripheral”, or “vision-based sensory device” is meant to include all types of optical image capturing devices including, without limitation, a single grayscale camera, monochrome video cameras, single monochrome digital CMOS camera with a wide field-of-view lens stereo cameras, and literally any type of optical image capturing device.

As used herein, the term “safety equipment deployment scheme” is meant generally to include a method of determining a classification of a vehicle occupant, as described below, and selectively deploying vehicle safety equipment. For example, in one aspect of the disclosed method and apparatus, if an occupant is classified as a child, the safety equipment deployment scheme comprises suppressing deployment of an airbag during a vehicle crash.

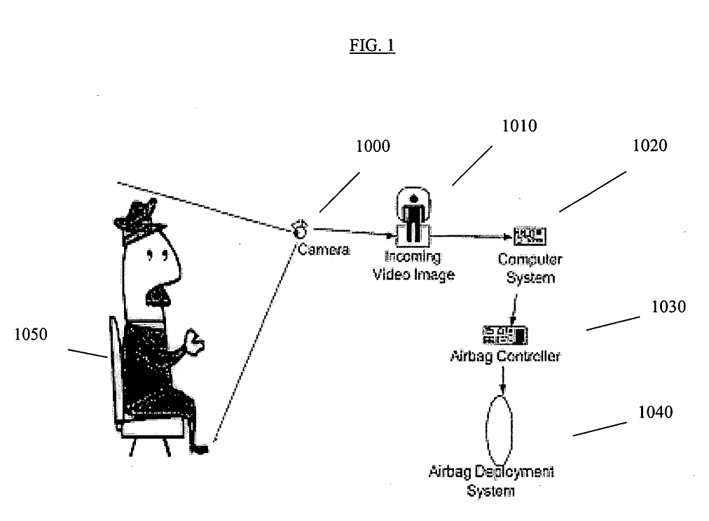

FIG. 1 shows a partial view of a surrounding environment, within a vehicle, for use with one embodiment of the disclosed method and apparatus. As shown in FIG. 1, in this embodiment, a camera 1000 captures images from the vehicle interior at a predetermined rate. As shown in FIG. 1, the camera 1000 obtains images of the occupant 1050. Incoming video images 1010 are transmitted from the camera to a computer system 1020. As described in more detail below, the computer system 1020 determines a classification of the vehicle occupant 1050, and transmits the classification information to an airbag controller 1030, in the event of an emergency. Subsequently, an airbag deployment system 1040 either deploys or suppresses deployment of an airbag, based upon the vehicle occupant classification information generated by the computer system 1020.

In the exemplary system, the computer system 1020 includes a digital signal processor (DSP). In one embodiment, the DSP comprises an Analog Devices 21161 SHARC DSP. In one embodiment, the DSP performs all of the image processing functions in real-time. It receives pixels from the camera via its Link Port. The DSP is responsible for system diagnostics and for maintaining communications with other subsystems in the vehicle via a vehicle bus. The DSP is also responsible for providing an airbag deployment suppression signal to the vehicle airbag control module.

In one exemplary embodiment, the camera 1000 is positioned in the roof liner of the vehicle along a vehicle center-line, and near the edge of the windshield. This positioning of the camera 1000 provides a near profile view of the occupant 1050 of the passenger seat, which aids in the accurate classification of the occupant. This positioning also reduces the likelihood that the occupant 1050 will inadvertently block the camera 1000. The typical field of view required for most passenger vehicles is roughly 100 degrees vertical Field of View (FOV) and 120-130 degrees horizontal FOV. This FOV ensures coverage of the occupant 1050, as the occupant 1050 moves from the instrument panel to the rear-most seating position (when the seat is fully reclined).

Image classification methods are typically applied to a single image. In many real-time applications, however, often a sequence of images is collected, and classification must be performed over a period of time. During operation, the system experiences a variety of changing conditions that may cause great variability in the robustness of the classification decision. These changes may be caused by variations in object orientation, illumination, and degree of occlusion.

The processing of classification results in a stream of accumulated evidence pertaining to the true class of a vehicle occupant. The task of continuous vehicle occupant classification can be solved using the techniques developed within the field of Evidential Reasoning. An evidential reasoning framework suits this occupant classification problem very well, where a fixed set of potential outcomes (object classes) are supplied over a period of time.

Evidential reasoning has been applied to systems that combine multiple classifiers, where the classifiers all operate on the same incoming data. They define three levels of abstraction at which the classifier outputs can be combined: (i) class label, (ii) ranks of all possible labels, or (iii) confidence measurement. The confidence measurement is used in one exemplary embodiment as it provides the most information.

Dempster-Shafer Theory of Evidence

As is well known by those skilled in the art, Dempster-Shafer Theory of Evidence is a mathematical tool for representing and combining measures of evidence and is particularly useful when knowledge is incomplete and uncertainties exist. Only actual knowledge is represented through this theory, thus eliminating any necessity to draw conclusions that would otherwise be premised on ignorance. The Dempster-Shafer theory is also known as the theory of belief functions, which is a generalization of the Bayesian theory of subjective probability. Dempster-Shafer theory is based on two basic principles: 1) obtaining degrees of belief for one question based on subjective probabilities for a related question, and 2) providing rules for combining such degrees of belief when they are based on independent evidence. Stated in another way, obtaining degrees of belief for a first question based upon probabilities for a second question.

More specifically, let Θ be a fixed set of mutually exhaustive and exclusive atomic hypotheses, i.e., Θ={θ₁, . . . . θₙ}, referenced to as the “Environment”, with each value of θ being a different hypothesis. For example, if a single die is rolled, then Θ would contain six propositions of the form “the number showing is i”, where 1≦i≦6; hence N is equal to 6 in this particular example.

Because DS theory is based upon a breakdown of atomic elements into subsets having varying likelihoods as evidence is obtained, the concept of a “Power Set” is important. A “Power Set” includes all possible answers to any given question that is posed to a system. The Power Set comprises all possible subsets and, for example, for a system of Θ={A, B, C}:
Power set=P(Θ)={ø, {A}, {B}, {C}, {A, B}, {A, C}, {B, C},{A, B, C}}
   Note that the elements A, B, C comprise mutually exclusive outcomes, wherein ø comprises the empty set, also known as “total ignorance”. A basic element of evidence in Dempster-Shafer is the “mass” or “basic probability assignment”. It has the following two properties that make it similar to Bayesian probability assignments:
m(ø)=0 and Σm(A)=1, where A⊂Θ)

One difference between Bayesian probability assignments and Dempster-Shafer theory is that Dempster-Shafer does not force belief to be assigned to the atomic elements that are defined in the complete power set, but only to the subset for which evidence has been directly accumulated. In Bayesian probability theory, all initial probability must be assigned to the elements, for example in a throw of a die, the probability of each number being rolled is set to 1/6 for the 6 possible outcomes. Any belief that is not assigned to the specific subsets A⊂Θ remains within the entire environment Θ, and evidence assigned to the entire environment is termed the amount of ignorance in the system, because applying evidence to everything means there is no confidence in what to believe. Another difference between DS and Bayesian probability theories is that the probability of an outcome does not comprise a single value, but rather a range of values, as noted above. The lower value is referred to as the “belief” in the proposition. The upper value comprises the “plausibility” in the proposition. The concept of a range of probabilities is critical in a number of mathematical representations of Evidential Reasoning. Mathematically, the “belief” and “plausibility” are defined as follows:
“Belief” function=Bel(X)=Σm(A), where A [symbol] X;
“Plausibility” function=Pls(X)=1−Bel(^{˜}X)=1−Σm(A), where A [symbol] ^{˜}X;
wherein, X∩^{˜}X=ø; and X∪^{˜}X=A.

X and Y represent elements in an environment for which you want to derive an understanding of its evidence of being the proper hypothesis (e.g., a “3” in the roll of the die). The belief and plausibility methods generally function to estimate the range of probability for specific subsets of the entire power set, given a known probability for some set of elements. Once again referring to the example of the thrown die, the belief in a thrown die being an even number for a given roll is the probability of rolling a “2”, “4”, and “6”.

A classifier, such as, for example, a vehicle occupant classifier, provides values for the masses for some outcomes of the system at each pass of a sensor. The “Belief” and “Plausibility” of each of the set of cases can then be evaluated. Thus, the next step in a classification method is to define a mechanism for combining new mass values into existing mass values. Newly captured data must be integrated in some manner into currently existing mass values. One approach in performing this integration uses the Dempster's Rule of Combination, which is defined as follows:
m₁⊕m₂(Z)={Σm₁(X)·m₂(Y)}/1−k
k=Σm₁(X)·m₂(Y); where X∩Y=ø; where k is the coefficient of normalization.

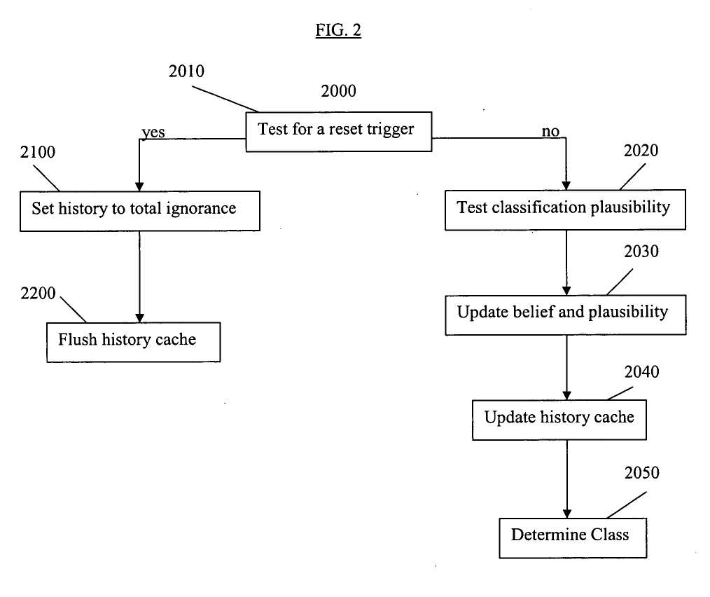

The continuous stream of classification outputs fro the system over time can be framed as a Classifier Combination problem. In one embodiment, a sequence of classifiers continuously accumulate evidence as to the correct classification of a vehicle occupant. The sequence of classifiers should then be incorporated into the current classification of the occupant. The DS theory and mathematical framework suits the problem very well. The application of DS theory to vehicle occupant classification is described below in more detail with reference to the description of FIG. 2.

One example of a system that uses Evidential Reasoning techniques is described in U.S. Pat. No. 6,304,833 (hereinafter the '883 patent). The '833 patent discloses a method for the selection of hypotheses for modeling physical phenomena. The method includes the steps of: detecting if selected features are present by analyzing actual sensed data and parameter values of an initial physical phenomena model; comparing feature estimating hypotheses to the actual data in order to determine a belief probability assignment (“bpa”) value for each of the hypotheses that indicates a likelihood that the selected features exist in the actual data and a likelihood that such selected features cannot accurately be determined as existing due to the presence of noise; selecting a set of the hypotheses most accurately modeling the physical phenomena based on the bpa of each selected hypotheses meeting a predetermined criteria; generating evidential support values and lack of evidential support values for subsets of the set having non-zero subset bpas; ranking the subsets having non-zero subset bpas in order of decreasing subset bpas; unioning subsets of the power set for forming unioned subsets and determining support values and plausibility values for the unioned subsets; comparing the unioned evidential support values to a predefined threshold value; and using at least one of the unioned subsets having a unioned evidential support value most closely approximating or exceeding the threshold value for selecting alternate models having selected features which more closely approximate the actual data.

Two mechanisms for managing modifications in the belief of a hypothesis are used, “belief revision” and “belief updating”. Belief revision is the element of belief change that involves integration of new information on a static situation. Belief updating involves modifying beliefs about an environment when the state of the environment is changing. There are many methods that can be used for belief revision, such as for example, a Transferable Belief Model (TBM) and Dempster-Shafer. Most of these approaches are related to the Dempster-Shafer theory. Therefore, DS Theory serves as a basis for an exemplary classification sequence processing method and apparatus.

Applying Dempster-Shafer to “Smart” Airbag Classification Sequences

In one exemplary embodiment of the present method and apparatus, the following elements are present, Θ={infant child, adult, empty}. Clearly, this set meets the requirement of a Dempster-Shafer environment of mutual exclusivity. It also meets the exhaustive requirement if the empty class also includes small objects on the seat.

FIG. 2 shows a block diagram of one exemplary embodiment of the disclosed historical vehicle occupant classification processing method 2000. The method 2000 may, for example, be implemented as part of a digital signal processor, memory storage, and a computing system that is used in an automated safety system in a vehicle such as that shown in FIG. 1.

As shown in FIG. 2, the method begins at a first STEP 2010 with a test for a history reset trigger. The test 2010 determines the presence or absence of a predetermined signal. The signal detection technique used in practicing the disclosed method may either be passive or active. That is, the test for a reset trigger circuitry may either actively send out a query signal to search for a predetermined signal, or passively wait to be signaled by a triggering device. In one exemplary embodiment, the predetermined signal comprises a signal generated when a vehicle door is opened or closed. In another embodiment, the trigger signal can be generated when the vehicle is stopped. In this exemplary embodiment, the predetermined signal may be designed to either transmit an impulse signal to the test circuitry, or circuitry may periodically poll the vehicle door, for example, to determine if it has been opened. The STEP 2010 determines if the current history must be reset to complete ignorance, or if the current stream of evidential inputs should continue to be integrated (as is described in more detail below).

If the trigger circuitry detects a reset signal, the classification method 2000 sets history to a state or total ignorance at a STEP 2100. In one exemplary embodiment, the history is implemented using an electrical memory storage device capable of preserving data input by a sensory device, such as a vision-based peripheral. Because the memory storage device functions generally to accumulate data regarding vehicle occupants, ignorance comprises the state wherein no data is accumulated about an occupant. That is, ignorance is the state wherein the memory storage device has no information about a vehicle occupant.

The method 2000 then proceeds to a STEP 2200 whereat a history cache is flushed. If the history is to be set to a state of total ignorance, the associated history cache must also be flushed, either sequentially or simultaneously. The STEP 2200 may be performed in serial or in parallel with the STEP 2100. The memory associated with an occupant is erased during the STEP 2200, because new information related to the vehicle occupant must be obtained and stored.

Referring again to the comparison STEP 2010, if the test for reset trigger is negative (i.e., no reset trigger is present), the method 2000 proceeds to test for classification plausibility at the STEP 2020. STEP 2020 is used to address the situation wherein past evidence to date has been of one class (e.g. an “adult”), and new evidence implies another class (e.g. a RFIS). It will be appreciated that there is a plurality of classifications having a mutually orthogonal relationship. That is, each classification is mutually exclusive of every other classification. In reality, these classes may generally have some overlap in the decision space and consequently there is a likelihood that the classifier output will transition from one class to another. The STEP 2020 tests the likelihood that the current classification is plausible given historical classifications. In one embodiment, STEP 2020 proceeds according to the following sub-steps:
a.) Store away current system belief vector containing beliefs of all possible outcome into the array Bel_last, such that Bel_vector=Bel_last;
b.) Update the Bel_vector using the new set of masses, New_mass_vector using the standard DS rules of combining, and create an array Bel_vector_new;
c.) Compute the sum of the absolute differences of the old and new beliefs: by delta_bel=sum(|Bel_last−Bel_temp|), where the sum is over all of the possible outcomes;

$$\vert Δ Bel \vert = {\sum }_{P ( Θ )} \vert {Bel}_{temp} - {Bel}_{last} \vert$$
d.) If delta_bel>threshold then there has been too much change so declare the incoming set of masses as improbable.

There are two mechanisms by which the occupant classification can vary over time, (i) deterministic and (ii) random. Deterministic variations occur due to occupant movement within the vehicle. Randomly occurring variations are caused by inherent overlap between classes in the decision space. In any classification system, there is always a potential for error between the two classes. If there was no chance for this error then the application would be trivial (e.g., determining grapefruits from dump-trucks). Real-world classifiers have an inherent probability of error, which is the error of classifying an item as class 1 when, in reality, it is class 2. This phenomenon is termed the random error in the decision.

Deterministic error, by definition, is not random. For example, when a vehicle occupant leans very far forward in a vehicle seat (such as occurs when the vehicle occupant leans forward to pick up an object on the vehicle floor) it is known that the occupant will appear to a vehicle sensor as an infant. Therefore errors in classification of a vehicle occupant due to occupant movement within the vehicle is deterministic because the posture of the occupant determines the class.
Both of these types of errors are addressed by testing the belief in the incoming classification relative to the historical beliefs as follows:

$$\vert Δ Bel \vert = {\sum }_{P ( Θ )} \vert {Bel}_{temp} - {Bel}_{last} \vert$$

If the change in belief value exceeds a certain threshold, then the transition is assumed to be too unlikely, and the current classification information is not integrated. Rather, the input classification is set to a state of complete ignorance. The overall belief in any particular classification is slowly degraded, as the questionable results are integrated into the classification history. This helps account for the condition where initial classifications are erroneous.

Transitions of the true object classes are impossible. For example, clearly a child will not grow into an adult during the length of a given drive, and, of course, an adult will not turn into an infant. It will be appreciated that there is some overlap between each potential occupant classification. That is, there will be data that will not, by itself, be determinative of which classification correctly categorizes the occupant. In other words, there will be information captured by the vehicle occupant sensory device that is common to all or some of the classifications. For example, a child may be the correct occupant classification, but when the child pulls a sweater off by extending her arms upward, the sensory device will capture information consistent with classifying the child as an adult.

The continuous stream of classification outputs from the system over time can be framed as a “Classifier Combination” problem. The sequences of classifiers each gather evidence as to the correct classification of the occupant. This past information must be incorporated into the current classification.

Hence, in one exemplary embodiment, during the classification plausibility test STEP 2020 of FIG. 2, a decision is made regarding whether or not to integrate current classification data with the historical classifications. The total change in belief is computed in accordance with the follow equation:

$$\vert Δ Bel \vert = {\sum }_{P ( Θ )} \vert {Bel}_{temp} - {Bel}_{last} \vert ;$$

Abs_belief_difference=sum(abs(temp_belief subsets−hist_belief_subsets)).
If the value of “Abs_belief difference” exceeds a predetermined threshold value, the transition from one classification to another is assumed to be too unlikely. The current classification therefore is not integrated with the historical classification data. In one embodiment, the predetermined threshold value is set to 0.4. Those skilled in the classification systems art shall appreciate that other thresholds can be used with the present disclosed method and apparatus. The thresholds can be varied to meet system requirements.

However, it is possible that all of the historical classification data is wrong. For example, in the exemplary embodiment, an adult may enter a vehicle, lean forward for an extended period of time, and then suddenly sit erect. Under these circumstances, the historical classification data suggests that the vehicle occupant classification is something other than an “adult”. In this case, plausibility fails, and the input to the classification processing is reset to “ignorance”. As such, the overall belief in the history slowly degrades. At some point the beliefs will be sufficiently low that the apparently contradictory information can be integrated and the evidence for a new class will begin to be accumulated.

The belief and plausibility updating STEP 2030 follows the definition of Dempster's rule of combination as set forth in the equation below:

$${m}_{1} ⊕ {m}_{2} ( Z ) = \frac{{\sum }_{X ⋂ Y = Z} {m}_{1} ( X ) \cdot {m}_{2} ( Y )}{1 - κ} , \\ where κ = {\sum }_{X ⋂ Y = ϕ} {m}_{1} ( X ) \cdot {m}_{2} ( Y ) .$$

In these equations, m1 is the existing mass at the last iteration of the system, m2 is the new incoming mass, and the sum “m1+m2” is computed for each element Z in the complete power set. The numerator sums together all of the probability mass for any two subsets X and Y whose intersection is the subset Z that is computed. For example, the subsets {infant, child}, and {child, adult} have the intersection {child}. Therefore, the product of the masses for each of these subsets sum together to provide one term for the {child} mass sum. Likewise, the denominator is a normalization term where the two terms X and Y are all combinations for which the intersection is the empty set, for example {infant, child} and {adult, empty}. In one embodiment, a power-set_flag_vector is created as an N×4 vector, where “4” is the number of atomic elements, and N is the number of elements in the power set:

The psedo-code below shows one exemplary embodiment of the belief and plausibility updating STEP 2030. Those skilled in the art will appreciate that other implementations are possible without departing from the scope of the disclosed method and apparatus.

% singletons first
class_power_set(1,1) = 1;
class_power_set(2,2) = 1;
class_power_set(3,3) = 1;
class_power_set(4,4) = 1;
% cardinality 2 set elements
class_power_set(5,1) = 1;
class_power_set(5,2) = 1;
class_power_set(6,1) = 1;
class_power_set(6,3) = 1;
class_power_set(7,1) = 1;
class_power_set(7,4) = 1;
class_power_set(8,2) = 1;
class_power_set(8,3) = 1;
class_power_set(9,2) = 1;
class_power_set(9,4) = 1;
class_power_set(1O,3) = 1;
class_power_set(10,4) = 1;
% cardinality 3 elements
class_power_set(11,1) = 1;
class_power_set(11,2) = 1;
class_power_set(11,3) = 1;
class_power_set(12,1) = 1;
class_power_set(12,2) = 1;
class_power_set(12,4) = 1;
class_power_set(13,1) = 1;
class_power_set(13,3) = 1;
class_power_set(13,4) = 1;
class_power_set(14,2) = 1;
class_power_set(14,3) = 1;
class_power_set(14,4) = 1;
% cardinality 4 element
class_power_set(15,1) = 1;
class_power_set(15,2) = 1;
class_power_set(15,3) = 1;
class_power_set(15,4) = 1.

A class_power_set_{—}1 and a class_power_set_{—}2 are defined. All of the elements for combining are added together. For example, for subsets X and Y, sum(class_power_set_{—}1(X,:)* class_power_set_{—}2(Y,:)). If this sum is 0, it means that the intersection between the two is zero. Otherwise, some element is common so it is included in the summation of the “m1+m2” equation above.

In one exemplary embodiment, a slight modification to Dempster's rule of combination (as set forth in the equations above) is incorporated into the disclosed method and apparatus that departs from traditional theory. More specifically, in this embodiment, some probability mass is added to the ignorance subset for every input classification. The mass in the ignorance is added by making m(15)=m(15)+0.05. Recall that m(15) comprises the mass for the last subset which is the complete set of {infant, child, adult, empty}. In addition, the sum of all masses is renormalized to one. This prevents the system from erroneously converging to a solution with Bel=1, which would prevent it from ever changing classes in the future. At this point, the traditional rule of combination is performed.

In one embodiment of the disclosed method and apparatus, a class_power_set_{—}1 and a class_power_set_{—}2 are defined. In an attempt to sum all of the elements for combining, for example, subsets X and Y, a sum(class_power_set_{—}1(X,:)*class_power_set_{—}2(Y,:)) is calculated. If this sum is 0 it means the intersection between the two subsets is zero, otherwise some element was common in which case it is included in the summation of the m1+m2 equation set forth above.

As shown in FIG. 2, the method 2000 then proceeds to a STEP 2030 to update the belief and plausibility. The masses are normalized by computing Sum(all m(X)) for all of the subsets X, then each of the m(X) is replaced by m(X)=m(X)/sum(all m(X)). The modification of the traditional rule addresses the following problem. When environmental data regarding an occupant has been collected over a long period of time, if the confidence for each classifier output is very close to 1.0 (i.e., 100% confidence), the belief in that class will converge to 1.0. After the belief in a particular hypothesis has converged to 1.0, the system cannot add newly captured information to the belief if data contradictory to the belief is captured by the camera. This behavior is manifest because the newly acquired information is orthogonal to the current belief, and therefore will be ignored in the rule of combination. To address this problem, some amount of mass is added into the complete ignorance subset. Subsequently, in one embodiment, the sum of all masses must be renormalized to sum to one. At this point, Dempster's rule of combination is performed.

Referring again to FIG. 2, once the new classification information is integrated into the current belief and plausibility values in the STEP 2030, the complete power set vector containing all of the beliefs and plausibilities are added into the history cache in STEP 2040. In one exemplary embodiment, the history cache comprises a rolling buffer of the last N classifications. It provides an additional smoothing function. Adequate performance may be achieved employing a buffer depth of 10, although it will be appreciated that other buffer depths may be used to practice the present teachings. Different buffer depths may provide improved performance under some conditions. In one embodiment, the final result of the system is the average of the beliefs and the plausibilities for all set elements for each of the frame times.

Referring again to FIG. 2, the method 2000 then proceeds to a STEP 2050 whereat the classification is determined. In one embodiment, the final classification is determined by computing average belief and plausibility values. In one embodiment, the average belief and plausibility values are calculated by averaging over the current history cache. This results in two complete sets of belief and plausibility values for the entire power set, referred to herein as classification set one and classification set two.

In one embodiment, the average of the probabilities for the last number of scans is computed as follows:

num_avg = min(num_cache_elements, max_scans);
for i=1:num_avg
avg_belief_subsets = avg_belief_subsets + belief_subsets_cache(:, i);
avg_plausibility_subsets=avg_plausibility_{—subsets} +
plausibility_subsets_cache(:, i); end
avg_belief_subsets = avg_belief_subsets/num_avg;
avg_plausibility_subsets = avg_plausibility_subsets/num_avg.

The average of the two sets is computed for each element in the power set. In one embodiment, the final subset of the power set comprises the classification that is output by the vehicle occupant classification system. In the exemplary embodiment, the list of possible subsets that can be output by the system comprise {RFIS}, {child}, {RFIS, child}, {adult}, {empty}. The average belief vector is then determined as follows:

```
belief_vect(1) = avg_belief_subsets(3); % from the power set location of
adult
  belief_vect(2) = avg_belief_subsets(4); % from the power set location
  of empty
    belief_vect(3) = avg_belief_subsets(5); % from the power set
    location of child/RFIS subset.
```

However, it will be appreciated by those skilled in the art that other embodiments include other types of subsets, depending upon a particular type of vehicle and the respective, mutually exclusive, vehicle occupant classifications.

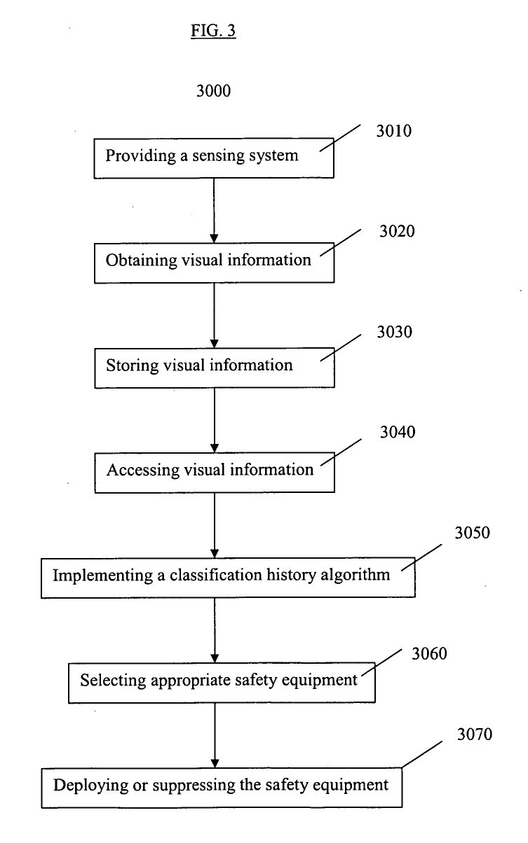

FIG. 3 is a simplified flowchart illustrating a method for obtaining and processing information to selectively suppress or deploy vehicle safety equipment. The first step of the method 3000 provides a sensing system at the STEP 3010. In the exemplary embodiment, the sensing system includes a video camera mounted on the vehicle for the purpose of obtaining visual information related to vehicle occupants. However, other types of sensing systems are contemplated, such as audio sensors, and other types of sensor systems capable of capturing information regarding vehicle occupants.

In the exemplary embodiment, at a STEP 3020, visual information regarding vehicle occupants are obtained and captured in a recordable format. In the exemplary embodiment, the information is visual data and will typically be stored as a series of image frames. A closely related step, a STEP 3030 of storing the visual information, may either be performed subsequent to, or simultaneously with, the STEP 3020.

The method then proceeds to a STEP 3040 where stored visual information is accessed. The stored visual information contains information required for updating the belief and plausibility functions as described above. However, other methods of Evidential Reasoning may be updated by the accessed visual information, without departing from the scope of the disclosed concepts.

The method then proceeds to a STEP 3050 whereat a classification history algorithm is implemented. In the exemplary embodiment, the STEP 3050 comprises utilizing the Dempster-Shafer theory to converge on a reliable approximation of the occupant classification. In one embodiment, this step proceeds as described above with reference to FIG. 2. Specifically, in the exemplary embodiment, the occupant classification may either be an adult, child, RFIS, or empty. It will be appreciated that each potential classification is an outcome that is mutually exclusive of the other potential outcomes. In other words, each potential outcome is orthogonal to one another, even though there may be some shared characteristics.

The method then proceeds to a STEP 3060 whereat appropriate safety equipment is selected based upon the occupant classification determined in the STEP 3050. The computing system converges on an occupant classification, and makes a decision as to the appropriate safety equipment to use under current conditions. Specifically, the conditions under which this decision must be made will be a real-time emergency, requiring immediate responsiveness from an automated safety system. In the exemplary embodiment, the safety system comprises an airbag deployment system. In this embodiment, if the occupant classification is empty, RFIS, or child, the airbag should not be selected for deployment. However, if the occupant classification is an adult, then the airbag should be selected for deployment under emergency conditions (such as a vehicle accident).

Other embodiments of the disclosed method and apparatus include many other types of safety mechanisms deployable by an automated vehicle safety system. For example, the door of the vehicle may automatically be selected to lock or unlock under a specified emergency condition, such as in the event of a vehicle accident. Also, the automated system could be configured to detect when a vehicle is underwater and to deploy appropriate safety equipment, such as automatically opening the windows or deploying a floatation device. Other examples of automated safety equipment include the automatic selection of broadcasting a Global Positioning System (GPS) signal, or other type of radio frequency signal, selectively enabling or disabling a traction system to aid with terrain traverses, and dynamically channeling shockwaves caused by an impact of a vehicle crashing throughout the framework of the vehicle.

The method proceeds to a STEP 3070 whereat the safety equipment selected at the STEP 3060 is selected for deployment or suppression.

### CONCLUSION

The foregoing description illustrates exemplary implementations, and novel features, of aspects of a method and apparatus for effectively providing integration of a classification history with newly acquired sensory information regarding vehicle occupants, adapted to selectively deploy or suppress safety equipment. Given the wide scope of potential applications, together with the flexibility inherent in digital design, it is impractical to list all alternative implementations of the method and apparatus. Therefore, the scope of the disclosed method and apparatus should be determined only by reference to the appended claims, and should not be limited by features illustrated or described herein except insofar as such limitation is recited in an appended claim.

While the above description has pointed out novel features of the disclosed method and apparatus as applied to various embodiments, the skilled person will understand that various omissions, substitutions, permutations, and changes in the form and details of the methods and apparatus illustrated may be made without departing from the scope of the disclosed method and apparatus. For example, vehicle occupants may have many meanings, including subsets other than human, such as for example, animals or inert entities. The exemplary embodiments describe an automobile having human vehicle occupants, but other types of vehicles having other types of occupants also fall within the scope of the disclosed concept.

Although not required, the disclosed embodiments are described in the general context of computer-executable instructions, such as program modules, being executed by a computer, such as a personal computer. Generally, program modules include routines, programs, objects, components, data structures, etc., that perform particular tasks or implement particular abstract data types.

Computer programs implementing the methods of the present method and apparatus will commonly be distributed to users on a distribution medium such as floppy disk or CD-ROM. From there, they will often be copied to a hard disk or a similar intermediate storage medium. When the programs are executed, they will be loaded either from their distribution medium or their intermediate storage medium into the execution memory of the computer, configuring the computer to act in accordance with the disclosed method and apparatus.

What is claimed is:

1. A method of classifying objects in a historical classification system, wherein the objects are assigned one of a plurality of mutually exclusive classifications over a period of time, and wherein a history of previous classifications for each object is maintained as a set of historical classifications for each object, and wherein each historical classification in a set has a corresponding and associated belief and plausibility value, comprising:
(a) obtaining a current classification of a selected object;
(b) determining whether the current classification of the selected object is plausible based upon the set of historical classifications for the object;
(c) integrating the current classification with the set of historical classifications and thereby generating an updated set of historical classifications for the object if the current classification is determined to be plausible in step (b), else discarding the current classification and proceeding to step (d);
(d) updating the belief and plausibility values associated and corresponding to the historical classifications for the selected object;
(e) computing a complete power set vector containing all of the belief and plausibility values accumulated by the method;
(f) computing average belief and plausibility values based on the complete power set computed in step (e); and
(g) classifying the selected object as one of the mutually exclusive classifications, based upon the computed average belief and plausibility values computed in step (f).

2. The method of classifying objects as set forth in claim 1, wherein images of the selected objects are obtained by a vision-based vehicle safety system.

3. The method of classifying objects as set forth in claim 1, wherein the classification system further includes a reset trigger, further including, before the obtaining step (a), determining whether the reset trigger is activated, and if so activated, resetting all historical classifications, belief and plausibility values in the system to a complete ignorance condition.

4. The method of classifying objects as set forth in claim 3, wherein the classification system further includes a memory for storing all of the historical classifications, belief and plausibility values in the system, and wherein the memory is cleared of all data if the reset trigger is activated.

5. The method of classifying objects as set forth in claim 4, wherein the system also includes a history cache for storing the power set vector, and wherein the history cache is also cleared of all data if the reset trigger is activated.

6. The method of classifying objects as set forth in claim 1, wherein the step of determining whether the current classification is plausible comprises the following substeps:
(1) calculating a current system belief vector Bel_vector and a previous system belief vector Bel_last (Belₗₐₛₜ), wherein Bel_vector contains current belief values of all possible classifications, and assigning Bel_vector=Bel_last;
(2) obtaining a new set of masses for the selected object, and updating Bel_vector based on the new set of masses using Dempster-Shafer rules of combining;
(3) calculating a new belief vector Bel_vector_new (Belₜₑₘₚ) based upon Bel_vector updated in step (2);
(4) calculating a delta_bel (ΔBel) value by summing absolute differences of the new belief vector Bel_vector_new and the previous belief vector Bel_last over all possible outcomes;
(5) comparing delta_bel to a threshold value; and
(6) determining that the current classification is not plausible if delta_bel exceeds the threshold value, else determining that the current classification is plausible.

7. The method of classifying objects as set forth in claim 6, wherein the step of calculating a delta_bel value is performed in accordance with the following mathematical expression:
$$\vert Δ Bel \vert = {\sum }_{P ( Θ )} \vert {Bel}_{temp} - {Bel}_{last} \vert .$$

8. The method of classifying objects as set forth in claim 7, wherein the updating the belief and plausibility values step set forth in step (d) is performed in accordance with the following mathematical expression:
$${m}_{1} ⊕ {m}_{2} ( Z ) = \frac{{\sum }_{X ⋂ Y = Z} {m}_{1} ( X ) \cdot {m}_{2} ( Y )}{1 - κ} , \\ where κ = {\sum }_{X ⋂ Y = ϕ} {m}_{1} ( X ) \cdot {m}_{2} ( Y ) .$$
and wherein m₁ comprises an existing mass at a last iteration of the system, m₂ comprises a new mass, and a sum m₁ and m₂ is computed for each element in the complete power set.

9. The method of classifying objects as set forth in claim 5, wherein the complete power set vector is stored in the history cache.

10. The method of classifying objects as set forth in claim 9, wherein the computing average belief and plausibility values of step (f) further comprises averaging the values stored in the history cache, and wherein the history cache comprises a rolling buffer of previous N classifications.

11. The method of classifying objects as set forth in claim 10, wherein the step of averaging values stored in the history cache yields a first and a second set of belief and plausibility values for the complete power set, and wherein an average of the first and second sets is computed for each element in the power set, and wherein a final subset of the power set comprises a classification output by the historical classification system.

12. The method of classifying objects as set forth in claim 11, wherein a list of possible subsets output by the historical classification system comprises {RFIS}, {child}, {RFIS, child}, {adult}, {empty}.

13. The method of classifying objects as set forth in claim 1, wherein the method is used in a vision-based automated vehicle safety system, wherein the vehicle safety system includes a video camera mounted within the vehicle and wherein vehicle occupants are classified by the historical classification system into one of a plurality of mutually exclusive classifications over a period of time, and wherein the vehicle safety system selectively suppresses and deploys vehicle safety equipment responsive to the occupant classifications.

14. The method of claim 13, wherein the vehicle safety equipment comprises an airbag deployment system.

15. An object classification system, wherein objects are assigned one of a plurality of mutually exclusive classifications over a period of time, and wherein a history of previous classifications for each object is maintained as a set of historical classifications for each object, and wherein each historical classification in a set has a corresponding and associated belief and plausibility value, comprising:
(a) means for determining a current classification of a selected object;
(b) means, coupled to the current classification determining means, for determining whether the current classification of the selected object is plausible based upon the set of historical classifications for the object;
(c) means, responsive to the means for determining the plausibility of the selected object, for integrating the current classification with the set of historical classifications and thereby generating an updated set of historical classifications for the object if the current classification is plausible and discarding the current classification if the current classification is not plausible;
(d) means, responsive to the integrating means, for updating the belief and plausibility values associated and corresponding to the historical classifications for the selected object;
(e) means for computing a complete power set vector containing all of the belief and plausibility values accumulated by the classification system;
(f) means, responsive to the complete power set computation means, for computing average belief and plausibility values based on the complete power; and
(g) means, responsive to the average belief and plausibility values computing means, for classifying the selected object as one of the mutually exclusive classifications, based upon the computed average belief and plausibility values.

16. An automated vehicle safety system, comprising:
(a) an imaging device capable of obtaining images of a vehicle occupant;
(b) a computing device, operatively coupled to the imaging device, wherein the computing device is configured to classify objects in accordance with the method set forth in claim 1, and wherein the vehicle occupant is classified as one of a plurality of mutually exclusive classifications; and
(c) an automated safety device, responsive to the computing device, wherein the safety device is selectively deployed based on the vehicle occupant classification as determined by the computing device.

17. The automated vehicle safety system set forth in claim 16, wherein the imaging device comprises a camera.

18. The automated vehicle safety system set forth in claim 16, wherein the computing device comprises a DSP.

19. The automated vehicle safety system set forth in claim 16, wherein the automated safety device comprises an airbag deployment system.

20. A computer program executable on a general purpose computing device, wherein the program is executed to classify objects in a historical classification system, wherein the objects are assigned one of a plurality of mutually exclusive classifications over a period of time, and wherein a history of previous classifications for each object is maintained as a set of historical classifications for each object, and wherein each historical classification in a set has a corresponding and associated belief and plausibility value, comprising:
(a) a first set of instructions for obtaining a current classification of a selected object;
(b) a second set of instructions for determining whether the current classification of the selected object is plausible based upon the set of historical classifications for the object;
(c) a third set of instructions for integrating the current classification with the set of historical classifications and thereby generating an updated set of historical classifications for the object if the current classification is determined to be plausible, else discarding the current classification;
(d) a fourth set of instructions for updating the belief and plausibility values associated and corresponding to the historical classifications for the selected object;
(e) a fifth set of instructions for computing a complete power set vector containing all of the belief and plausibility values accumulated by the method;
(f) a sixth set of instructions for computing average belief and plausibility values based on the complete power set; and
(g) a seventh set of instructions for classifying the selected object as one of the mutually exclusive classifications, based upon the computed average belief and plausibility values.
